(19) United States
(12) Patent Application Publication
(10) Pub. No.: US 2007/0131043 A1
(43) Pub. Date: Jun. 14, 2007

(54) Ballast test dummy

(76) Inventor: Martha Louisa Frost, Houston, TX (US)

Correspondence Address: David M Ostfeld;Adams and Reese, 4400 One Houston Center, 1221 McKinney, Houston, TX, 77010, US

(21) Appl. No.: 10/579,437

(22) PCT Filed: Nov. 15, 2004
(86) PCT No.: PCT/US04/38125

§ 371 Date: May 15, 2006

Related U.S. Application Data
(60) Provisional application No. 60/519,974, filed on Nov. 14, 2003.

(51) Int. Cl. G01M 19/00

(52) U.S. Cl. 73/866.4

(57) ABSTRACT

A test dummy apparatus is disclosed that is shaped in the form of a human body with separate parts that can be each filled with fluid whereby the apparatus will have the size, weight and weight distribution of a human body. The connections of the parts allow for movement of the pieces such that the apparatus can be adjusted into multiple body positions (e.g., standing, sitting, crouching, etc). The parts can be assembled, disassembled and reassembled to allow for movement of the apparatus in pieces.

### CROSS REFERENCES TO RELATED APPLICATIONS

This application claims priority of U.S. Provisional Application Ser. No. 60/519,974 filed Nov. 14, 2003.

### BACKGROUND OF THE INVENTION

1. Field of the Invention

This invention relates to models for simulating the shape and weight of the human body, and in particular, to fill needs in the test of automobiles, amusement park rides, seating components of all type and any apparatus that needs to simulate the body's mass.

2. Prior Art

BARTS™ water ballast test dummy is the primary current model utilized in the industries of automobiles, amusement park rides, etc. Over the past eight (8) years sales of the BARTS™ water ballast test dummies have been made to the automotive industry, as well as a variety of other industries, to be used to simulate body weight while performing a variety of tests including braking, axle capacity, seat abrasion, road handling and tire traction, accident re-enactments and for litigation purposes. The BARTS™ water ballast test dummy has been used in the majority of the major accident re-enactments for litigation such as the Ford/Firestone tire problem and the Ford 15-passenger van rollover problem.

The BARTS™ test dummy is the equivalent of a bottle shaped like the body from the neck to the knees. These are made of LLDPE and are rotationally molded with a 3″ spin weld fill opening at the neck and a ½″ spin weld drain plug at the “knees”. The side of the dummy has weight markings so it can be filled to the desired weight level.

It is believed that Frost Products Mfg. is the only company in the U.S. that manufactures this type of dummy. The other known test dummy manufacturer is in France. The French version, which is like the BARTS™, only provides for weights up to 145 lbs. (below the automobile and amusement park testing standards), and they must be purchased in quantities of a container load. In addition to the French version, recently a European ride manufacturer created a type of water ballast test dummy that appears to only fit their style of ride and cannot be used in any other industry because of its use specific design shape of a truncated dummy, specially shaped.

The test dummy of the prior art:
a. only fits a portion of the today's rides; mainly standard bench seat rides with only lap bars;
b. does not fit the seat that is used for major velocity rides, spiral rides, or 360-degree roller coasters due to the harness and belt system utilized to secure a person in these type seats and the inability to use these restraints when using the BARTS™ test dummy;
c. does not provide a complete weight distribution and mass representation of the human body since they do not have arms, true legs or a head;
d. cannot be used for slalom, stand-up or lay-down rides due to non-articulating design; and
e. cannot be used to simulate the human body standing or laying down.

Prior to and currently the amusement parks use sand bags roped to the bottom of the ride or over the seat in order to simulate weight. There are some obvious inherent problems with this method. They include:
1. time to load and strap sand bags to seat;
2. employee back strain from lifting these bags;
3. injury to people on the ground from bags falling out of the seat during testing;
4. does not test harness and locking system;
5. the mess made from sand spilling out over the park when a bag breaks during testing; and
6. they do not accurately depict the weight distribution of a person.

The next level of known test dummies is more electronic, computerized and/or structural in their design and usage. The other known test dummies are the following.
a. Biofidelic Human Seating Surrogate Apparatus—U.S. Pat. No. 6,206,703 B1 discloses a biofidelic human seating surrogate apparatus capable of simulating human loading by duplication of the geometry and load distribution of a human at an interface with the vehicle seat to be tested;
b. Seat test Body—U.S. Pat. No. 6,009,750 discloses a seat test body that is provided for vibration measurements;
c. Test dummy submarining indicator system—U.S. Pat. No. 3,841,163 discloses a test apparatus for indicating the degree of submarining of an anthropomorphic dummy under deceleration; and
d. Dummy for car crash testing—U.S. Pat. No. 4,701,132 discloses that it is an anatomical model, particularly a dummy, for simulating the effect of an accident on the human body.

### SUMMARY OF THE INVENTION

This new test apparatus design is for the purpose of creating an articulating body form that can be filled with any type of material that can be contained by plastic or rubber (hard or soft), in order to simulate the human body's weight, weight distribution, mass and possible density and temperature of the human body. (The possible density of the human body is only created by filling the apparatus cavities with certain types of material).

The apparatus form is created using plastic, or plastic type materials, or rubber (hard or soft) that are formed into the shape of the various body parts, i.e. head with neck, torso with neck, or head and torso combined; articulating thighs; articulating lower legs with formed stationary or articulating feet, articulating upper arms; and articulating lower arms with formed stationary or articulating hands. Each body part may have at least one fill cavity with a fill/drain plug. Optionally, each body part will have fill markings on them that define the weight equivalent in pounds should the apparatus be filled to that point with water. This allows for the apparatus to be used to simulate various body weights as desired for the test.

This apparatus is to be used for simulating the human body (current deign is for an average person height of 5′10″ and 175 lbs.; however, other designs may be created in the same fashion that simulate a child of various age groups, a pregnant woman and/or an obese person).

The thigh and torso are connected preferably using multi-positioning in order to allow for the apparatus to be placed in a sitting position or standing position, or, alternatively, the apparatus may have the knees angled up and down towards the chest or be placed in a sitting position with the knees separated apart. Alternatively, the thighs may not be moving. They may be separated only or with the knees spread open or straightforward and in a standing position. The thigh and lower leg are connected in order to allow for a sitting, standing or crouching position. These positions will be “locked” into place so that the position is held during usage. The arms will be connected to the torso at the shoulder level and will be able to articulate up and down as well as bend, or otherwise pivot, at the “elbow”. The head as presently connected is a part of the torso, but may alternatively have a head which is separate from the torso and attached via various means, including screw into the neck of the torso, screw onto the torso or a bayonet attachment.

The apparatus is for the use in a variety of tests in which the human weight, mass, temperature and density are required in order to depict the appropriate use of the devise being tested. These tests may include:
a. seat durability,
b. seat abrasion,
c. axle testing,
d. restraint systems,
e. load testing,
f. road testing of vehicles,
f rollover testing,
g. accident re-enactment,
h. mattress testing,
i. wheelchair lifts,
j. elevator weight capacity,
k. airplanes weight capacity,
l. seating design structure,
m. G-force tests, and
n. similar body weight, mass and temperature.

Alternative apparatus styles may include the following for other test:
a. ball and socket joints at the hips, knees, elbows and shoulder;
b. a hip rod that has an articulating joint between the torso and thigh connection;
c. a shoulder connection with an articulating joint between the torso and shoulder,
d. a rod with a spring attached between two rigid pins in which the spring component will be placed between the two plastic parts and the rigid pins will be placed through the plastic parts and bolted at the ends;
e. additional drain/fill openings to allow the flow of heated liquid throughout the apparatus;
f. articulating feet and hands; and
g. a separated head and torso.

### BRIEF DESCRIPTION OF DRAWINGS

For further understanding of the nature and objects of the present invention, reference should be had to the following figures in which like parts are given like reference numerals and wherein:

FIG. 1-A is the cross section view of the torso/head taken along the section lines 1-1 view of the right side (facing FIG. 1-B) of the torso/head of the device of present invention.

FIG. 1-B is a cross section view of the torso/head taken along the section lines 1-2 of the back half of the torso/head (facing FIG. 1-D).

FIG. 1-C is a view of the torso/head component from the under side.

FIG. 1-D is an outside view of the right side (facing FIG. 1-B) of the torso/head component.

FIG. 1-E is a view of the backside of the torso/head component of the device of present invention

FIG. 1-F is the top view of the torso/head component

FIG. 2-A is a front view of the thigh portion of the left leg of the device of present invention.

FIG. 2-B is the outside view of the right side (facing FIG. 2-A) of FIG. 2-A.

FIG. 2-C is a cross section of the thigh taken along the section lines 2-1, a vertical center section line, of FIG. 2-B. The view is an inside view of the left side (facing FIG. 2-B) of the thigh.

FIG. 2-D is an angled, outside, left side (facing FIG. 2-A) view of the thigh.

FIG. 2-E is an angled, outside, right side (facing FIG. 2-A) view of the thigh

FIG. 2-F is the top view of the thigh component.

FIG. 3-A is a front view of the lower right leg of the device of present invention.

FIG. 3-B is a cross section of the lower leg taken along the section lines 3-1, a vertical center section line, of FIG. 3-A. The view is an inside view of the left side of the lower leg (facing FIG. 3-A).

FIG. 3-C is the outside view of the right side (facing FIG. 3-A) of FIG. 3-A.

FIG. 3-D is an angled, downward view of the right side (facing FIG. 3-A) of the lower leg.

FIG. 3-E is the top view of the lower leg component.

FIG. 4-A is a front view of the fully assembled device of present invention, showing the horizontal knee sitting position.

FIG. 4-B is a cross section of the fully assembled part taken along the vertical section lines 4-1 of FIG. 4-A.

FIG. 4-C is a cross section of the fully assembled part taken along the vertical section lines 2 of FIG. 4-A.

FIG. 4-D is a cross section of the fully assembled part taken along the vertical section lines 4-3 of FIG. 4-A.

FIG. 4-E is a cross section of the fully assembled part taken along the vertical section lines 4-4 of FIG. 4-A.

FIG. 4-F is a right side (facing FIG. 4-A) angled view of the fully assembled part.

FIG. 5-A is a front view of the fully assembled device of present invention, showing the crouching position with a 111° angle at the hip and knee area.

FIG. 5-B is a cross section of the fully assembled part taken along the vertical section lines 5-1 of FIG. 5-A.

FIG. 5-C is a cross section of the fully assembled part taken along the vertical section lines 5-2 of FIG. 5-A.

FIG. 5-D is a cross section of the fully assembled part taken along the vertical section lines 5-3 of FIG. 5-A.

FIG. 5-E is a cross section of the fully assembled part taken along the vertical section lines 5-4 of FIG. 5-A.

FIG. 5-F is a right side (facing FIG. 5-A) angled view of the fully assembled part.

FIG. 6 is a diagrammatic representation of a cross sectional view of a raised drain/fill opening with a plug closing device.

FIG. 7 is a diagrammatic representation, partly in phantom line, of a cross sectional view of a raised drain/fill opening with a cap dosing device.

FIG. 8-A is diagrammatic representation of a front view of the left arm component, both lower and upper sections.

FIG. 8-B is a diagrammatic representation of a side view of FIG. 8-A.

FIG. 9-A is cross section inside view of FIG. 9-B, taken along the vertical section lines 9-1.

FIG. 9-B is an outside view of the left side of the left leg component of the fully assembled apparatus.

FIG. 10-A is a representative drawing of the lower section of the torso component with a spring and swivel hip attachment.

FIG. 10-B is a representative drawing of the thigh component with a spring and swivel hip attachment.

FIG. 11 is a representative drawing of the lower portion of the torso component and thigh component with a ball-and-socket hip attachment.

FIG. 12-A is a representative drawing of the lower portion of the torso component with a swivel hinge hip attachment.

FIG. 12-B is a representative drawing of the thigh component with a swivel hinge hip attachment

FIG. 13-A is a representative drawing of a cross section view of the hip joint with a view from the underside of the torso component

FIG. 13-B is a representative drawing of a cross section view of the thigh component with a wedge shaped insert for hip attachment.

FIG. 13-C is a representative drawing of a cross section view of the thigh component with a wedge shaped insert for hip attachment, pin and locking block.

FIG. 14-A is a representative drawing of a lower portion of the torso component and the upper portion of the thigh component with a block-and-pin hip attachment.

FIG. 14-B is a representative drawing of a cross section view of the underside of the torso component with a block-and-pin hip attachment presented in a sitting position.

FIG. 15-A is a cross section view of the fully assembled apparatus taken along the lines 15-1 presented in a standing position. The view is an inside view of FIG. 15-B.

FIG. 15-B is an outside view of the left side (facing FIG. 15-C) of the fully assembled part, presented in a standing position.

FIG. 15-C is an outside view of the back of the fully assembled apparatus, presented in a standing position.

FIG. 16-A is a diagrammatic representation of a cross section view taken along section 16-1 of the side of the head component with a bayonet neck attachment.

FIG. 16-B is an angled, outside view of the head component with a bayonet neck attachment

FIG. 16-C is an outside view of the front of the torso component separated from the head component and having a bayonet neck connection.

FIG. 16-D is a top view of FIG. 16-C.

FIG. 16-E is an outside view of the tight side (facing FIG. 16-D) of FIG. 16-D.

FIG. 16-F is an outside view of the back of the head component.

FIG. 16-G is a top view of FIG. 16-F.

FIG. 17 is diagrammatic representation of the fully assembled part showing the adjustment for temperature regulation of the apparatus.

FIG. 18-A is an angled view of the left side (facing FIG. 18-B) of the torso/head component

FIG. 18-B is a downward angled view of the front of the torso/head component.

FIG. 18-C is an angled view of the right side (facing FIG. 18-B) of the torso/head component.

### DESCRIPTION OF THE INVENTION

The test apparatus of the present invention can be made out of a variety of plastic type materials including, but not limited to, polyethylene, plastisol, PVC, EVA and elastomeric plastic, or it may be formed of hard or soft rubber. The body components can be made using a variety of molding methods, including, but not limited to, cast, injection, blow molding and rotational molding, all of which are common in the art. A mold in the shape of each apparatus part is made (how it is made and out of what material depends upon the method of the desired molding process). Once the mold is made, the part is created using the desired process. After each part is formed then the drain/fill openings will be created in each component to allow for the filling and draining of each part cavity with the desired substance, of which the most popular substance will be water. The body parts can either be filled and then connected together or put together and then filled. The drain/fill openings may be created by various procedures common in the art, including spin welding, which occurs after the molding is completed, molding in the opening or use of a metal fitting, the later two of which are inserted during the molding process.

A. Torso/Head Component:

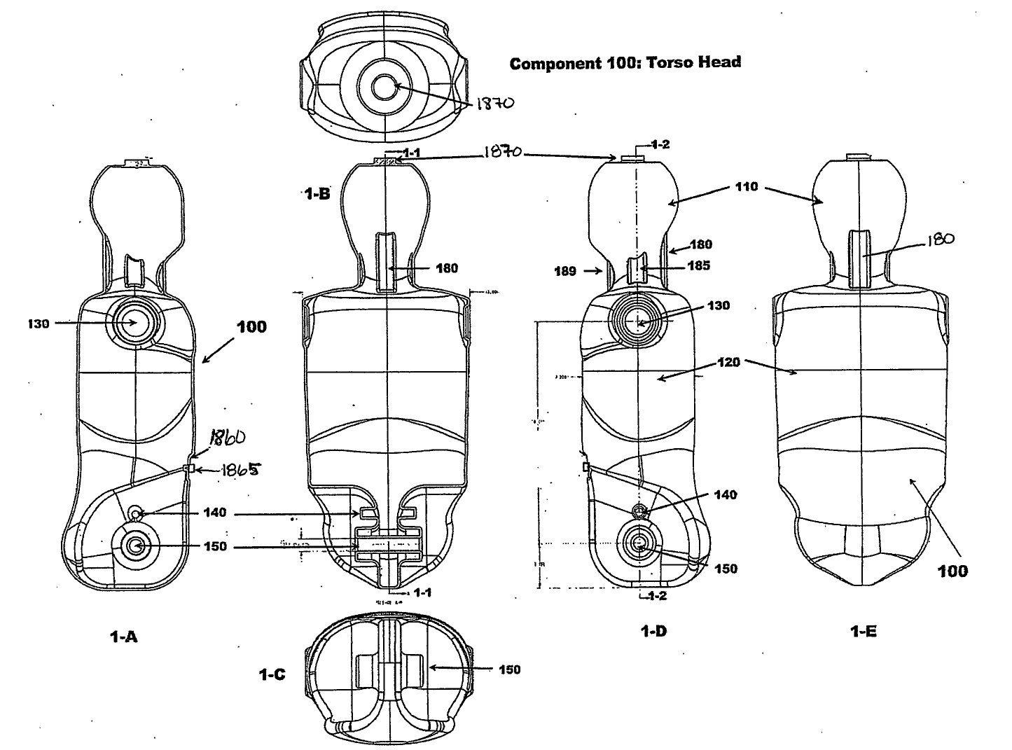

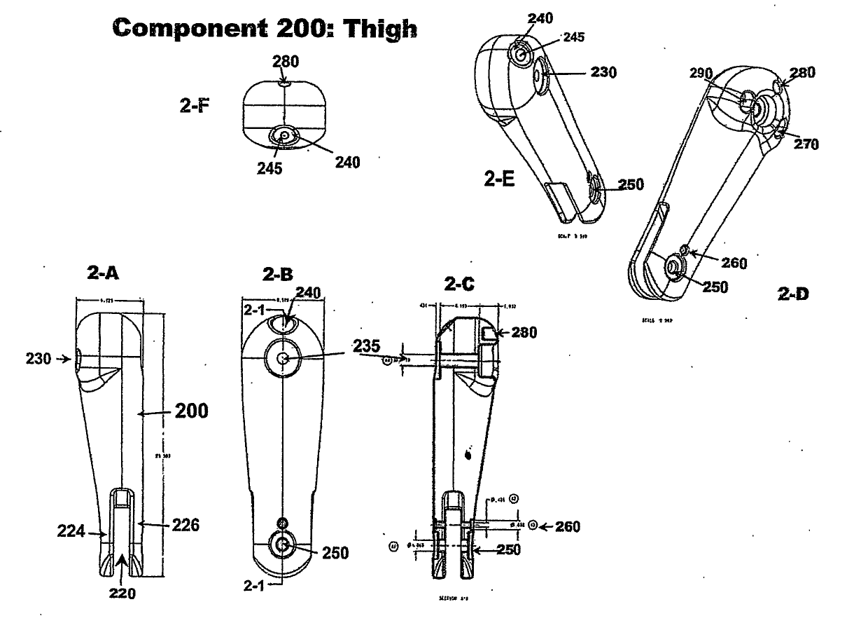

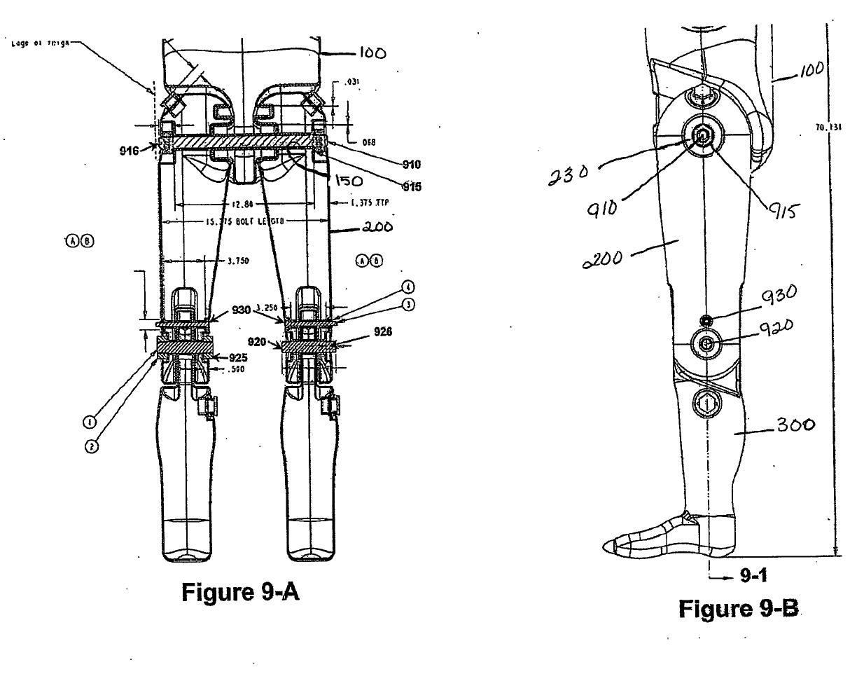

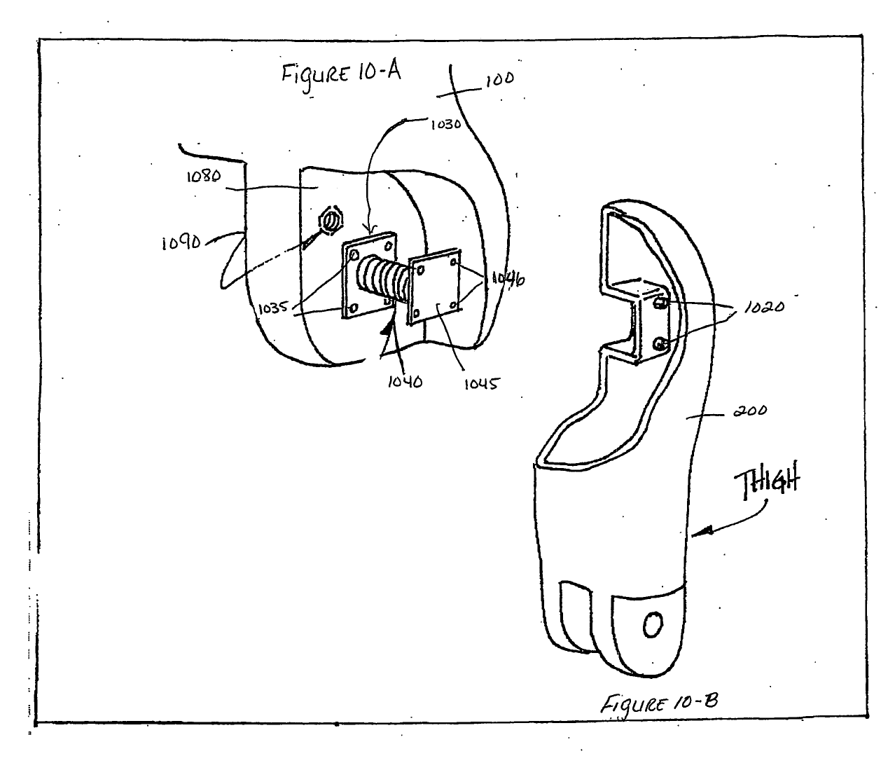

As shown in FIGS. 1-A through 1-F, the torso/head component 100 of the preferred embodiment of the present invention is shaped in human form. Except as indicated below, the torso/head component 100 is shaped to emulate a human torso and head. The torso/head component 100 is symmetrical along section line 1-1 such that the right side of FIG. 1-B is a mirror image of the left side of FIG. 1-B. Therefore, when either side is referred to, the equivalent will apply to the non-referenced side. As shown in FIG. 1-B on the lower portion of the torso/head component 100, there is an area formed that includes an axle tunnel 150, formed during the molding process, through which a rod 910 (FIG. 9), preferably 1″ diameter 14″-15″ long, having male threaded ends 916 is passed and secured by female threaded nuts 915 on each end 916 on either side of tunnel 150 in order to prevent the rod from sliding through the tunnel 150 openings. The rod 910 is utilized to connect the thigh section 230 to the torso section 100 and to allow for the pivot of the thigh 200. The rod 910 may be smaller or larger, or a different pivot mechanism can be used. There are various means for attaching the thigh 200 to the torso/head 100 still allowing for the articulating movement, including the use of a hollow or solid metal rod or a hollow or solid plastic rod, and each of these could be secured by various means, including having nuts on each end, having a bolt head on one end and a nut on the other, or using cotter pins on one or both ends.

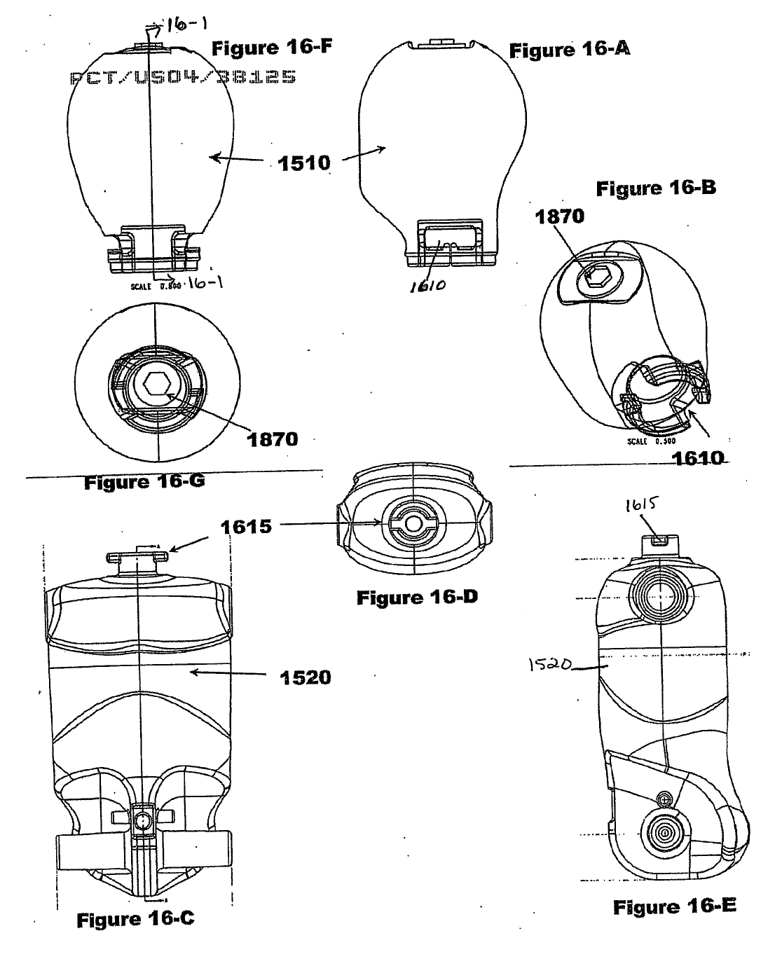

The preferred embodiment apparatus is shown with having the head and torso combined into a single part 100. The head 110 to torso 120 connection is reinforced with elevated plastic braces 180, 185, 189 created during the molding process. There is a brace 180 on the back of the neck and a brace 185 on each side and a brace 189 on the front of the neck. As mentioned earlier, the head and torso may be separated into two separate parts. In such case, the head 1510 can be attached to the torso 1520 in various ways, including having the head 1510 with a female receptor screw onto the torso 1520 with a male extension or having the head 1510 with a male extension screw into the torso 1520 with a female receptor. Additionally, the head 1510 may be connected to the torso 1520 using a bayonet connection. This type of connection uses a spring and interlocking shapes (FIG. 16A-16H) for the head 1510 and torso 1520. The head 1510 has a horizontal ‘U’ shape connection 1610 in which a corresponding shaped mechanism 1615 on the torso 1520 is inserted. Then a spring (not shown) is used to hold the head 1510 and torso 1520 locked in position.

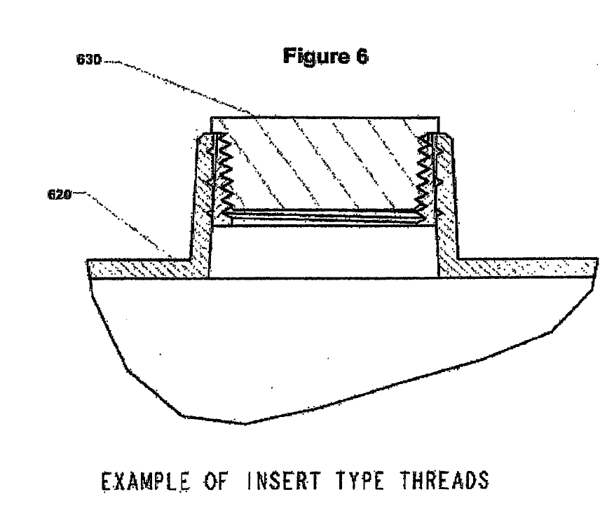

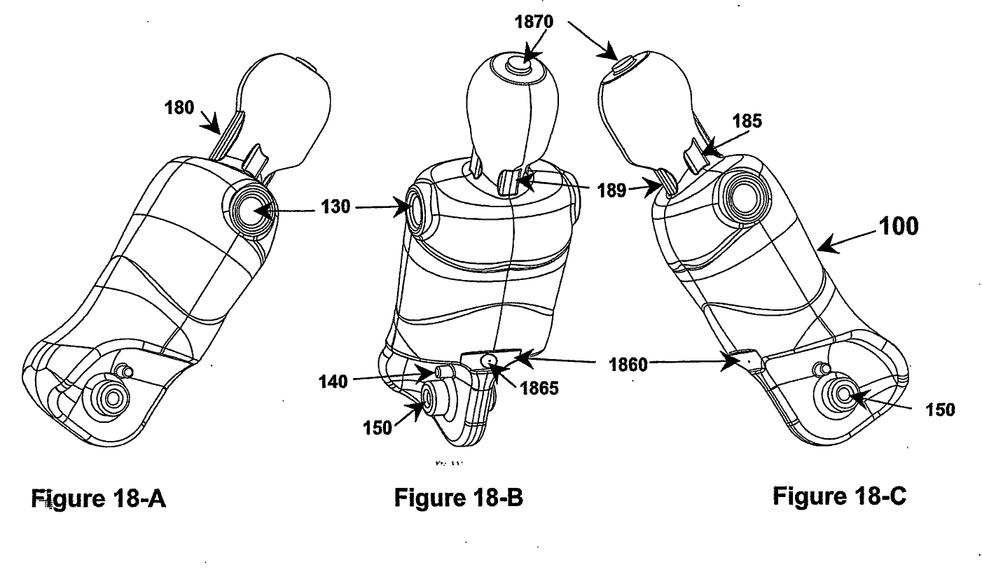

As shown in FIG. 18-B, section 1860 is a solid skinned, recess area formed in the molding process in which a drain/fill opening 1865 is preferably later created by spin welding, which is common in the art. As mentioned earlier, this drain/fill opening 1865 may be formed in various ways, including spin welding, which occurs after the molding is completed, molding in the opening or use of a metal fitting, the later two of which are inserted during the molding process. In addition, the drain/fill plug 1865 may be either raised from the body surface 620 (FIG. 6) and dosed with a plug 630, as shown, or recessed into the body surface 620 and dosed with a plug 630, not shown.

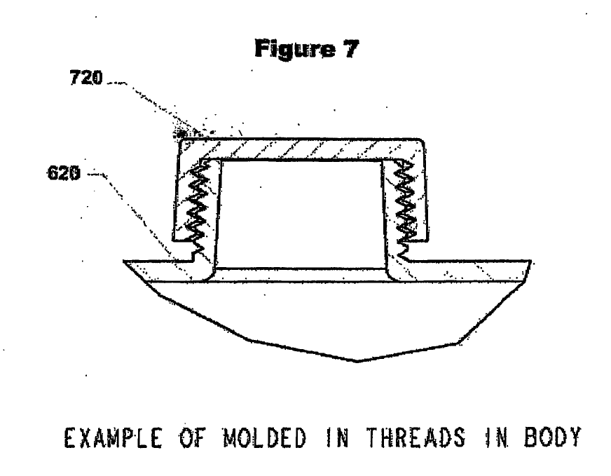

Section 1870 is a fill opening that can be formed by the same means as the drain/fill opening 1865. The fill opening 1870 may be closed by a plug 630 (FIG. 6) or a cap 720 FIG. 7), depending on how the fill opening 1870 is created. The fill opening 1870 can be inset into the head, or it can be elevated, as shown.

Additionally, as shown in FIG. 1-B, a section 140 is the positioning peg onto which recessed areas 270, 280, 290 of the thigh component 200 are placed depending on what position the legs are set—standing, sitting or 111°.

There are a number of different methods in which to attach the thigh 200 to the torso 100. These methods include, but are not limited to, the following:

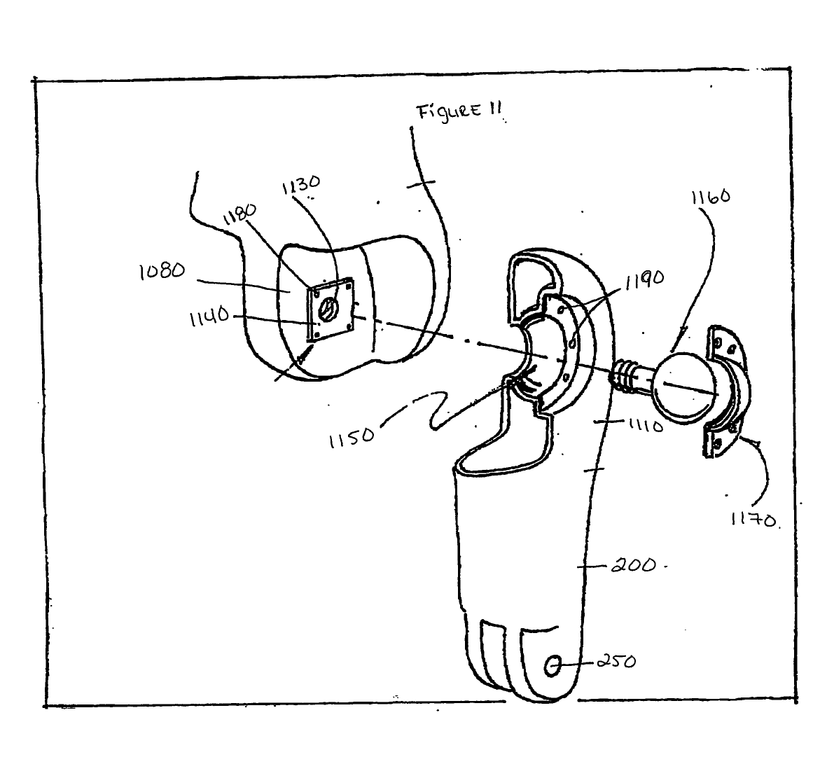

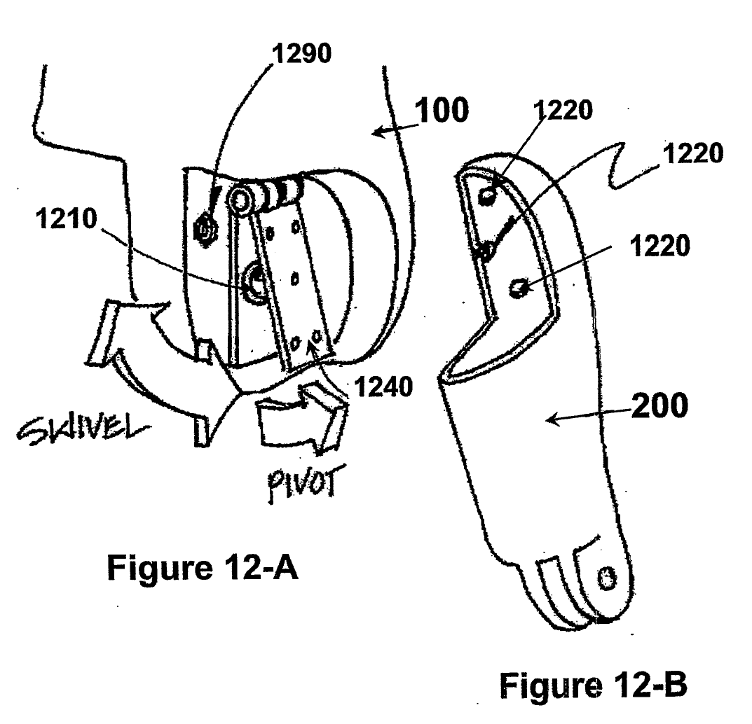

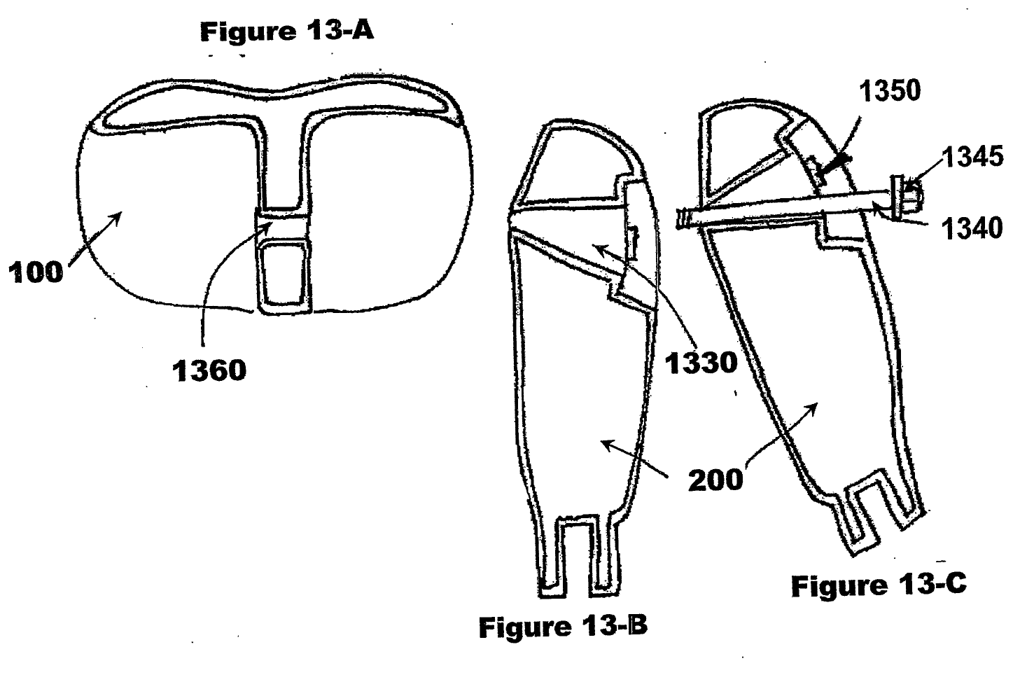

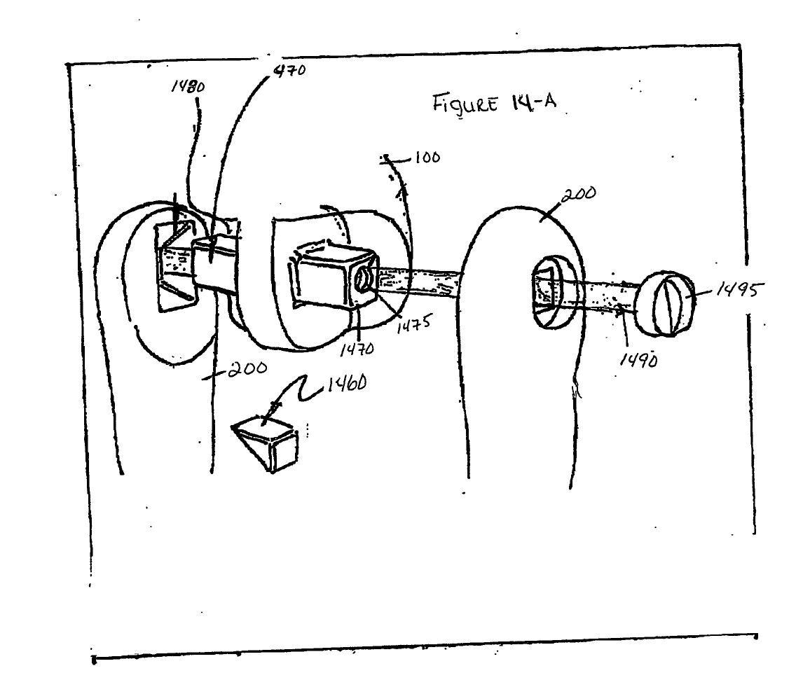

a. In the molding process a female screw insert 1090 (FIG. 10) is molded into the wall of the torso 1080 on each side. This insert 1090 receives a pin 930 that is put through a hole in the thigh 235 and screwed in at the time that the thigh 200 and torso 100 are attached in order to lock the thigh (200) in a standing or sitting position. Additionally, an insert plate 1030 (FIG. 10) with four female screw receivers 1035 is molded into the torso area portion 1080 on each side and four inserts 1020 are molded into the thigh portion 200 at the attachment point. After production a coil spring 1040 with swivel head 1045 is attached to the torso 100 by screwing four screws in the female inserts 1035 and the other end of the coil springhead is attached to the thigh 200 by screwing four screws in the female inserts 1020 locate in the thigh through holes 1046 in the swivel head 1045. This allows for the legs to be positioned in a stand or sitting position as well as the allowing for the legs to be opened and pivoted outward. This method of thigh 200 attachment allows both up and down movement of the thigh 200 and in and out movement as well.

b. In the molding process a female threaded opening 1130 is created in the wall of the torso area portion 1080 and four female inserts 1180 are molded around the opening. Additionally, a socket area 1150 (FIG. 11) is molded into the thigh 200. In the outside wall 1110 of the thigh 200 and around the opening of the socket 1150, female inserts 1190 are molded into the wall of the thigh 200 in the amount of an equal number to match the screw openings in the cover plate 1170. After production a metal plate 1140 is screwed into the inserts 1180 surrounding component 1130. Then a ball with threaded shaft 1160 is screwed through the thigh 200 into the torso-threaded opening 1130. Next the cover plate 1170 is placed over the socket ball 1160 and screwed into place. This method of thigh 200 attachment will allow multi-directional movement of the thigh 200 in order to accommodate multiple positioning of the apparatus depending on testing needs.

c. In the molding process, a female threaded insert 1290 is molded into the wall of the torso 100, one on both sides. In addition, a larger female insert 1210 is molded into the wall of the torso 100 on each side. Four female inserts 1220 are molded into the inside of each thigh 200. After production one side of a swivel hinge plate 1240 is screwed into the larger female insert 1210 and the other side is screwed into the female inserts 1220 molded into the inner thigh 200. Once the apparatus is placed in its desired position a locking pin 930 is screwed into the locking pin insert 1290 in order to lock the apparatus in the desired position. This method of thigh 200 attachment allows both up and down movement of the thigh 200 and in and out movement as well.

d. A cone shaped wedge opening 1330 is molded into each thigh 200. A torso opening 1360 is molded through the torso 100 to fit the size of the pin 1340 which is placed through the thigh opening 1330, then through the torso opening 1360 and then through the thigh opening 1330 in the other thigh 200. The pin 1340 has a cap 1345 screwed onto the each end. In addition, a locking bolt 1350 is placed in the wedge area 1330 in order to lock the leg 200 into the desired position.

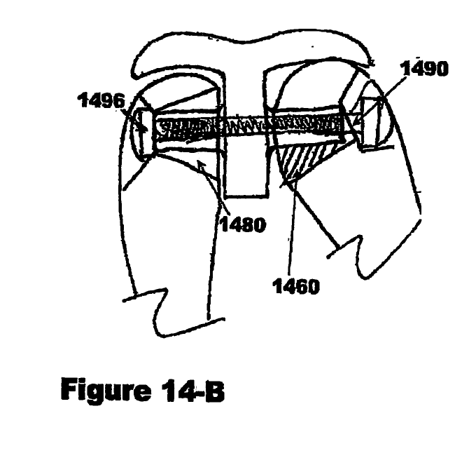

e. The torso design for this concept has been modified to allow for a rectangular peg 1470 (FIG. 14) with a center opening 1475 to be created at the time of molding. During the molding of the thigh 200, a rectangular wedged hole 1480 is created. To place the apparatus in its desired position the following is done:
1. The thigh 200 is placed in the sitting or standing position by placing the square peg joiner 1470 of the torso 100 into the rectangular wedge hole 1480 of the thigh 200.
2. A metal or rigid plastic pin 1490, with a cap 1495 on one end, is put through the opening 1480 in the thigh 200 from the outside in, though the torso opening 1475 out the other side through the other thigh 200 from the inside out, and a locking nut 1496 is screwed on to the end of the pin 1490. The leg 200 is then able to pivot out. An optional locking wedge 1460 can be placed in the wedge hole 1480 to lock the position of the leg 200.

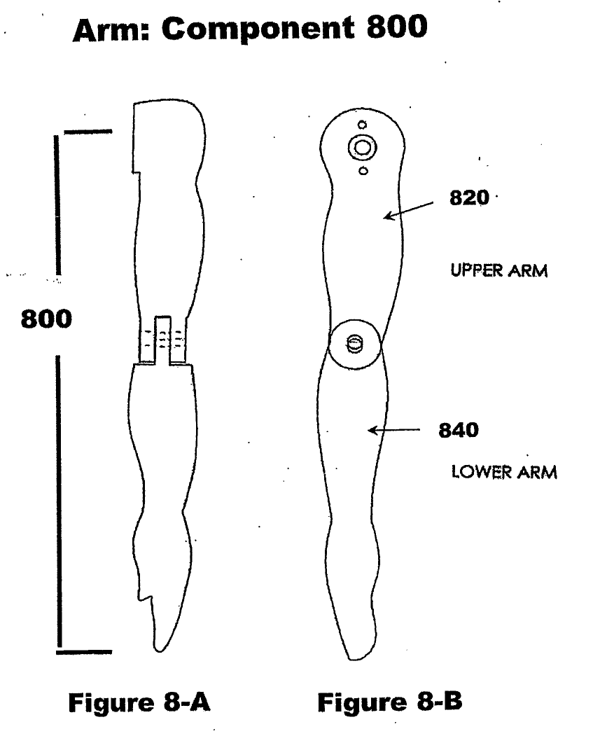

FIG. 1-D shows section 130, which is the recessed area for an arm 800 (FIG. 8) to be attached. In order to have the arms 800 articulate in a similar fashion as the leg 200, the same concepts that are used for joining the thigh 200 to the torso 100 may be utilized for joining the upper arm 820 to the torso 100 at section 130. Similarly, the joining of the lower arm 840 to the upper arm 820 will be created by the same means of joining the lower leg 300 to the thigh 200, thereby having multi-positional articulating movement.

B. Thigh Component:

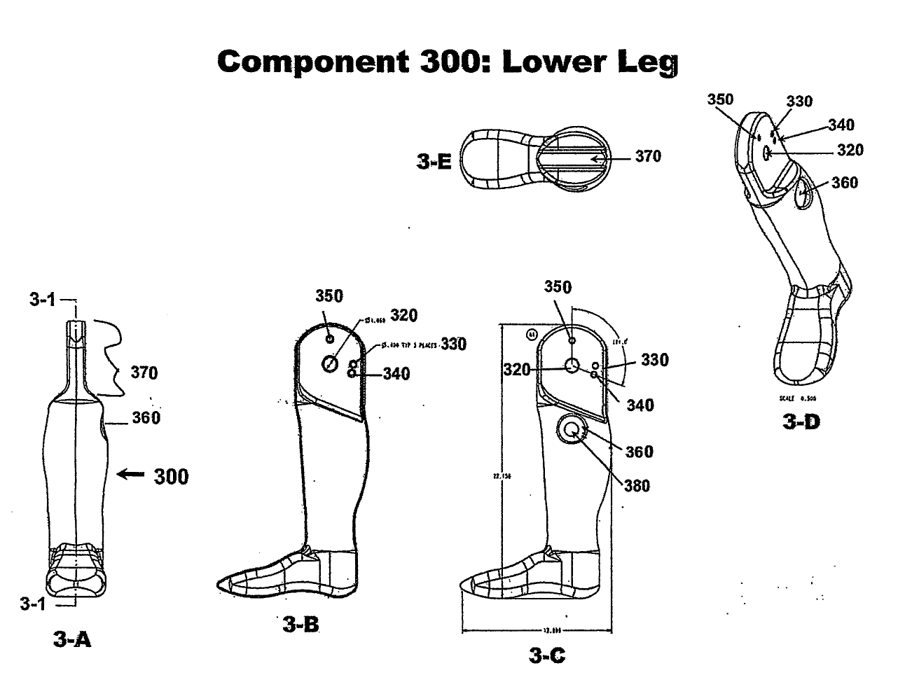

As shown in FIGS. 2-A through 2-F, the thigh component 200 of the preferred embodiment of the present invention is shaped in human form. Except as indicated below, the thigh component 200 is shaped to emulate a human thigh. As shown in FIG. 2-B, section 230 is a recessed area that includes an axle tunnel 235, formed during the molding process. A rod 910, preferably 1″ diameter 14″-15″ long, having male threaded ends 916 is passed through tunnel 235 and secured by female threaded nuts 915 on each end 916 on each side of tunnel openings 235 in order to prevent the rod 910 from sliding through the tunnel openings 235. The rod 910 is utilized to connect thigh 200 to the torso section 150 and to allow for the pivot of the thigh 200. The rod 910 may be smaller or larger, or a different pivot mechanism can be used, as mentioned earlier.

Also shown in FIG. 2-B is section 240 that is a solid skinned, recess area in which a drain/fill opening 245 is formed in the molding process. This drain/fill opening 245 may be formed by spin welding, which is common in the art, or by such other means as set forth for drain/fill opening 1865.

As shown in FIG. 2-D, the upper portion of the thigh 200 has three positioning wells 270, 280, 290 that are placed on section 140 of the torso/head component 100. Sections 270, 280, 290 are recessed areas that determine the position of the legs 200, 300. Inserting positioning peg 140 into one of the leg positioning recessed areas 270, 280, 290 sets the position of the thigh 200. Since thigh component 200 is interchangeable for either the left or right leg sections, sections 270, 290 are used depending on which side of the torso 100 it is being placed. Recessed area 290 is used when the thigh is placed as the right leg and the apparatus is set in a sitting or crouching position, and recessed area 270 is used for the left leg when the apparatus is set is a sitting or crouching position. Recessed areas 270, 290 allow for the leg to be positioned in a sitting or crouching position with the thighs parallel to the ground and at 111°. Recessed area 280 is utilized for the standing position.

As shown in FIG. 2-A, the lower portion of thigh component 200 has a slot formed by sides 224, 226. Section 220 is the area of the thigh 200 in which the lower leg section 370 is placed. Section 220 includes an axle tunnel 250 formed during the molding process through each side 224, 226 of the recessed area 220. A rod 920, preferably 1″ diameter 4.5″-5″ long, having male threaded ends 926 is passed through tunnels 250 and is secured by female threaded nuts 925 on each end 926 on the outside of each tunnel 250 in order to prevent the rod 920 from sliding through the tunnel 250 openings. The rod 920 is utilized to connect lower leg section 370 to the thigh component “knee” section 220 and to allow for the pivot of the knee. The rod 920 may be smaller or larger or a different pivot mechanism can be used, as mentioned for rod 910 above.

Section 260 is a tunnel also formed in the molding process. This tunnel 260 is used to guide a positioning bolt or other connector 930 through the corresponding openings 330, 340, 350 of the lower leg 300 knee in order to position and secure the lower leg 300 in a standing, sitting or 111° angle. The same variations mentioned possible for the rod 920, above, are possible for the positioning bolt 930.

C. Lower Leg Component:

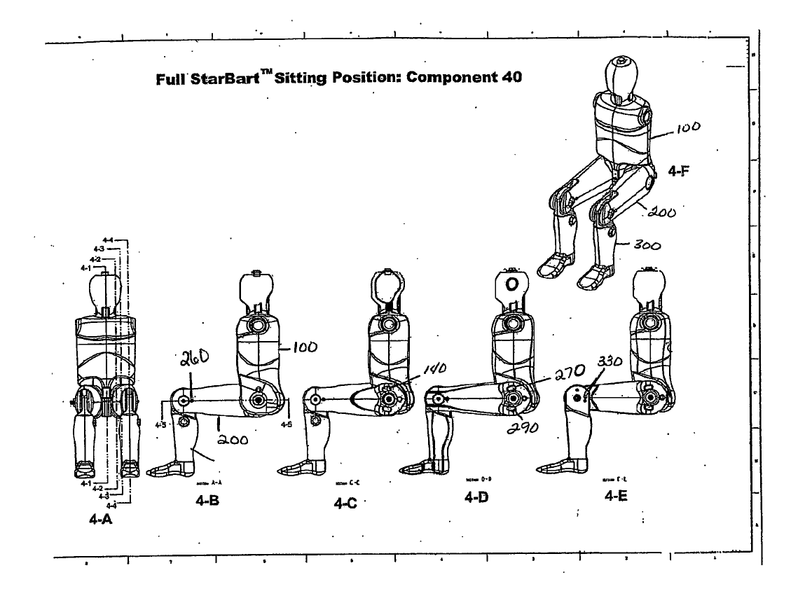

As shown in FIGS. 3-A through 3-E, the lower leg component 300 of the preferred embodiment of the present invention is shaped in human form. Except as indicated below, the lower leg component 300 is shaped to emulate a human lower leg. As shown in FIG. 3-A, the leg component 300 has an upper section 370. Section 370 is the section of the lower leg that is placed inside the recessed “knee” area 220 of thigh 200. Section 370 includes an axle tunnel 320 formed during the molding process through which a rod 920, described earlier, is passed and which is secured on either side of tunnel 320 in order to prevent the rod 920 from sliding through the tunnel 320 openings. The rod 920 is utilized to connect section 370 to the knee component 220 of the thigh 200 and to allow for the pivot of the knee. The rod 920 may be smaller or larger, or a different pivot mechanism can be used, as mentioned earlier.

Section 370 (FIG. 3) further includes tunnels 330, 340, 350 also formed in the molding process. These tunnels 330, 340, 350 are used to guide a positioning bolt or other connector 930 through the openings 260 in the thigh 200 in order to position and secure the lower leg 300 in a standing, sitting or 111° angle. The same variations mentioned possible for the rod 920, mentioned earlier, are possible for the positioning bolt 930. Positioning tunnel 350 is the positioning tunnel for standing. Positioning tunnel 340 is the positioning tunnel for the 111° bent knee. Positioning tunnel 330 is the positioning tunnel to secure the leg in the sitting position FIG. 3).

Leg component 300 further includes a solid skinned, recess area 360 formed in the molding process in which a drain/fill opening 380 is later inserted. This drain/fill opening 380 may be formed by spin welding, which is common in the art, or it may be created by the other various means mentioned earlier for the drain/fill opening 1865.

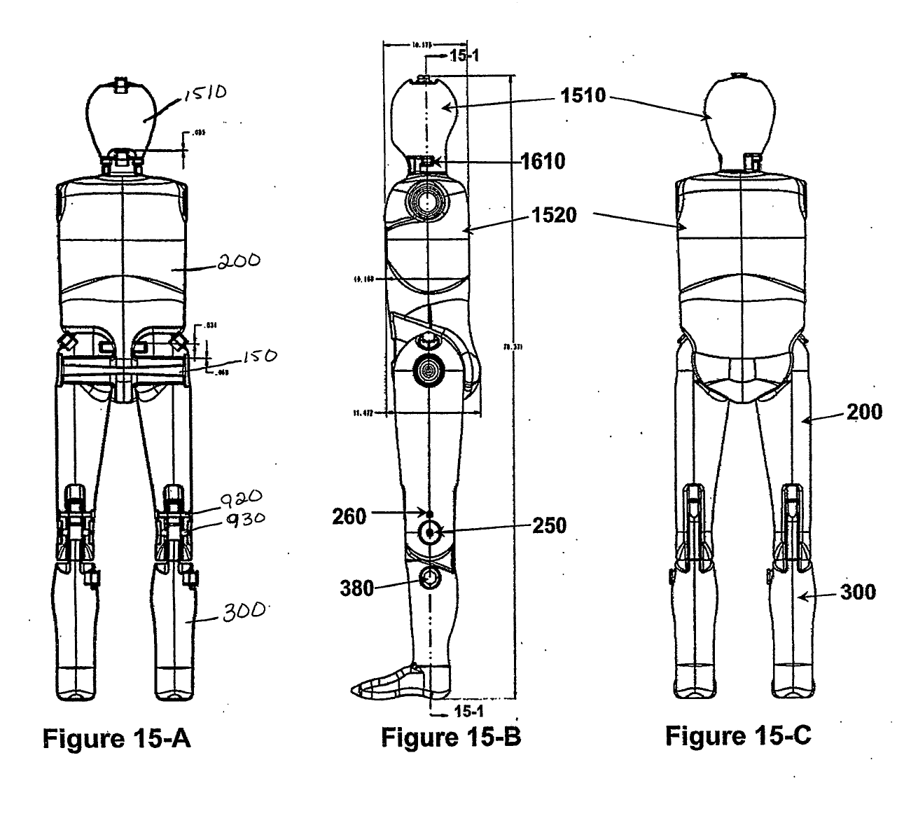

FIGS. 15-A through 15-C illustrate the complete apparatus in the standing position. This version of the apparatus is presented with the head 1510 and neck 1520 as separate components and connected by a bayonet connection 1610. When the apparatus is in a standing position, the torso 1520, head 1510, thigh 200 and lower leg 300 are in a vertical line as compared to the floor. Opening 260 is where a pin 930 would be placed that would hold the upper leg 200 and lower leg 300 in the standing position.

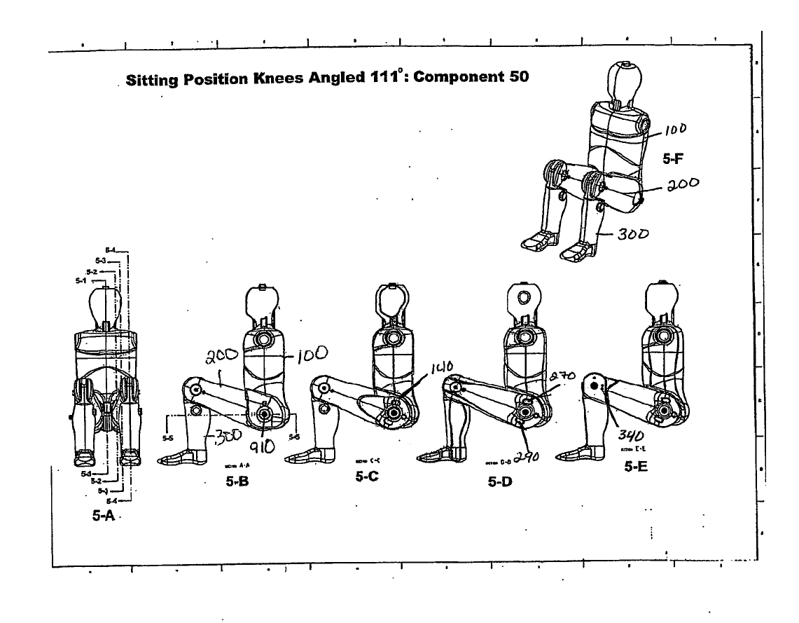

FIGS. 4-A through 4-H illustrate the complete apparatus in a sitting position with thighs 200 parallel to the ground. When the apparatus is in the horizontal knee sitting position, the torso 100 is perpendicular to the thigh 200, and the thigh 200 is perpendicular to the lower leg 300. In FIG. 4-C it is shown where position pin 140 is placed in recessed area 270 of the left leg of the apparatus to hold the torso 100 and thigh 200 in place. Recessed area 290 would be used for the right leg. Position pin 930 is passed through opening 260 of the thigh 200 and tunnel 330 of the lower leg to hold the thigh 200 and lower leg 300 connection in place.

FIGS. 5-A through 5-H illustrate the complete apparatus in a crouching position with knees and hips at a 111° angle. When the apparatus is in this crouching position, the knees are moved closer to the torso 100, and the lower leg 300 is adjusted to be parallel to the torso 100. To adjust the leg from the horizontal knee sitting position to the crouching position, the positioning pin 140 slides within recessed area 270 of the left leg (or 290 of the right leg) while the thigh 200 rotates around rod 910. Then the positioning pin 930 is removed to allow the lower leg to rotate around rod 920, and then the pin 930 is placed through tunnel 340 of the lower leg to hold the knee joint in position.

Although the apparatus has been shown and discussed in only three positions—standing, sitting, and crouching—the various positions of the hip could be combined with any of the positions of the knee to create other possible positions of the complete apparatus.

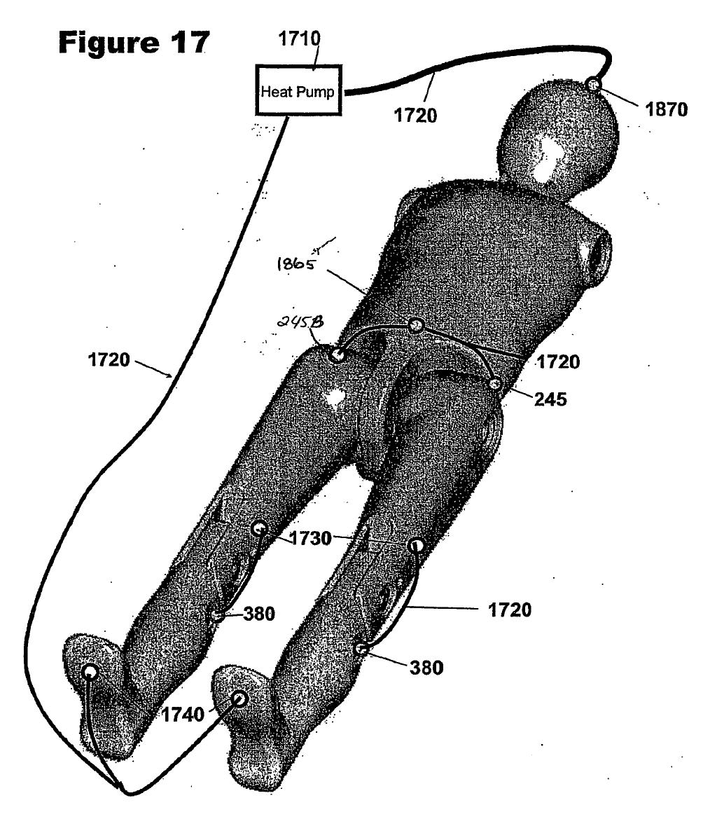

FIG. 17 illustrates the adjustments that can be made in order to make the apparatus temperature regulated so as to reflect the human body temperature for certain testing. The only changes that need to be made are the addition of a liquid heating pump 1710 that circulates liquid into the fill opening 1870 in the head 110. The heated liquid then flows out of drain/fill opening 1865 through hoses 1720 to drain/fill opening 245 and new drain/fill opening 245B in the thigh 200. The new drain/fill opening 245B is necessary so the apparatus can lie on its side for testing and allow room for the hose 1720. The heated liquid then flows out of new drain/fill openings 1730 via hoses 1720 to existing drain/fill openings 380. The liquid then flows out of the apparatus through new drain/fill openings 1740 back to the heating pump 1710.

Because many varying and different embodiments may be made within the scope of the invention concept taught herein which may involve many modifications in the embodiments herein detailed in accordance with the descriptive requirements of the law, it is to be understood that the details herein are to be interpreted as illustrative and not in a limiting sense.

1. A test figure comprising:
a set of body parts with connector elements, said body parts being connected with each other by said connector elements to form a human body shape;
filler material;
each of said body parts having an interior opening to receive said filler material;
each of said body parts having at least one opening to receive said filler material in said part.

2. The test figure of claim 1, wherein each of said body parts has a drain to evacuate said filler material in said part.

3. The test figure of claim 1, wherein said body parts include two lower legs, two thighs and one torso.

4. The test figure of claim 1, wherein said connector elements lock at least some of said body parts in fixed relationship to each other.

5. A test figure, comprising:
a set of shaped body parts;
connector elements at least partly mounted on said body parts;
said connector elements interconnecting said body parts;
said connector elements having locking mechanisms to hold said body parts in at least one set position with respect to each other.

6. The test figure of claim 5, wherein said body parts are comprised of plastic type material.

7. The test figure of claim 5, wherein said body parts are comprised of rubber.

8. The test figure of claim 7, wherein said rubber is hard.

9. The test figure of claim 7, wherein said rubber is soft.

10. The test figure of claim 5, wherein said body parts include a pair of lower legs, a pair of thighs and a torso.

11. The test figure of claim 10, wherein said thighs are articulating.

12. The test figure of claim 10, wherein said torso includes a head with a neck.

13. The test figure of claim 10, wherein said torso includes arms.

14. The test figure of claim 13, wherein said arms are upper arms.

15. The test figure of claim 14, wherein said upper arms are articulating.

16. The test figure of claim 14, wherein said upper arms are not articulating.

17. The test figure of claim 14, wherein said upper arms include lower arms.

18. The test figure of claim 17, wherein said lower arms are articulating.

19. The test figure of claim 17, wherein said lower arms form elbows with said upper arms.

20. The test figure of claim 17, wherein said lower arms are not articulating.

21. The test figure of claim 17, wherein said lower arms include hands.

22. The test figure of claim 21, wherein said hands are articulating.

23. The test figure of claim 21, wherein said hands are not articulating.

24. The test figure of claim 10, wherein said torso may connect to said thighs in multiple different positions.

25. The test figure of claim 10, wherein said thighs may connect to said lower legs in multiple different positions.

26. The test figure of claim 25, wherein the connection of said thighs and said lower legs form knees.

27. The test figure of claim 26, wherein said knees are angled up toward said torso.

28. The test figure of claim 26, wherein said knees are separated.

29. The test figure of claim 26, wherein said knees are in a sitting position.

30. The test figure of claim 26, wherein said knees are straight forward.

31. The test figure of claim 10, wherein there is included a head as an integral part of said torso.

32. The test figure of claim 10, wherein there is included a head detachably connected to said torso.

33. The test figure of claim 10, wherein said body parts are in an erect position.

34. The test figure of claim 10, wherein said body parts are in a reclining position.

35. The test figure of claim 10, wherein said body parts are in a sitting position.

36. A test figure for use of material to vary weight, comprising:
a set of shaped body parts, including a set of thighs, a set of lower legs, a torso;
each of said body parts having at least one connector to connect it to at least one other body part;
fill mechanisms mounted on said body parts to independently permit the introduction of fill material to vary the weight of each of said body parts.

37. The test figure of claim 36, wherein said fill mechanism is a drain mechanism for the fill material.

38. A test figure for use with a temperature controlled substance, comprising:
a set of shaped body parts;
each of said body parts having at least one connector to connect it to at least one other body part;
at least one fill mechanism mounted on each body part, said fill mechanisms arranged to permit the flow of the substance between said body parts, whereby the body parts are maintained substantially at the same temperature.

39. A test figure, comprising:
a set of shaped body parts;
connector elements at least partly mounted on said body parts;
said connector elements detachably interconnecting said body parts.
